(19) United States
(12) Patent Application Publication
(10) Pub. No.: US 2026/0172442 A1
(43) Pub. Date: Jun. 18, 2026

(54) VULNERABILITY DETECTION METHOD OF POWER INDUSTRY CONTROL PROTOCOLS BASED ON FEDERATED MULTI-AGENT REINFORCEMENT LEARNING

(71) Applicant: China Three Gorges University, Yichang City (CN)

(72) Inventors: Shouzhi XU, Yichang City (CN); Yannan JIAO, Yichang City (CN); Mei YU, Yichang City (CN); Tian WU, Yichang City (CN); Jia ZHU, Yichang City (CN); Huan ZHOU, Yichang City (CN); Xiaojun LIU, Yichang City (CN); Yang LI, Yichang City (CN); Bibo XIAO, Yichang City (CN); Kai MA, Yichang City (CN); Rui CHEN, Yichang City (CN); Liang ZHAO, Yichang City (CN); Ke WANG, Yichang City (CN); Liping FAN, Yichang City (CN)

(73) Assignee: China Three Gorges University, Yichang City, HB (CN)

(21) Appl. No.: 19/531,562

(22) Filed: Feb. 5, 2026

(30) Foreign Application Priority Data
Dec. 1, 2025 (CN) 202511794737.X

(51) Int. Cl. H04L 9/40; H04L 41/16

(52) U.S. Cl. CPC H04L 63/1433; H04L 41/16

(57) ABSTRACT

The present disclosure discloses a vulnerability detection method of power industry control protocols based on federated multi-agent reinforcement learning, which belongs to a technical field of the intersection of power Internet of Things security detection and artificial intelligence. The detection method includes: s1: collecting data and structured processing; s2: initializing multi-agent array and dual network; s3: integrating federated reinforcement learning to process data; s4: detecting protocol vulnerabilities through collaborative architecture and intelligent decision-making; s5: carrying out decentralized execution, implementing joint fuzzy testing and result feedback. The present disclosure adopts the vulnerability detection method of power industry control protocols based on federated multi-agent reinforcement learning, improving a zero-day vulnerability response speed to meet real-time protection requirements of the power system; improving detection efficiency; where avoiding sensitive data leakage, complying with compliance requirements; achieving multi-party cross-domain collaborative protection and reducing collaborative detection problems caused by data silos.

### TECHNICAL FIELD

The present disclosure belongs to a technical field of the intersection of power Internet of Things security detection and artificial intelligence, and specifically relates to a vulnerability detection method of power industry control protocols based on federated multi-agent reinforcement learning.

### BACKGROUND ART

The power Internet of Things is moving towards a stage of deep integration and a large-scale application, and core businesses such as power production scheduling, equipment operation and maintenance, and user interaction are highly dependent on data transmission and instruction interaction functions of industrial control protocols. However, design flaws and version compatibility issues inherent in industrial control protocols, coupled with continuous iteration of new attack methods, have become major security risks that threaten the stable operation of power systems and even cause grid paralysis.

However, existing detection technologies have the following shortcomings: traditional vulnerability mining relies on pre-defined static test case sets, which are difficult to adapt to a dynamic operating environment and complex protocol state migration of the power Internet of Things, and cannot meet the real-time security protection needs of the power system. The existing detection technology mostly adopts a centralized single-agent architecture, which is difficult to fully cover the multi-field and multi-state characteristics of power industrial control protocols, limiting the improvement of detection efficiency. The traditional centralized training mode requires the sharing of raw protocol data, facing sensitive data leakage risks and compliance challenges, making it difficult to achieve cross-domain collaborative security protection.

Therefore, there is an urgent need for a new method.

### SUMMARY

The purpose of the present disclosure is to provide a vulnerability detection method of power industry control protocols based on federated multi-agent reinforcement learning, which improves a zero day vulnerability response speed to meet real-time protection needs of a power system, enhances detection efficiency, avoids sensitive data leakage, meets compliance requirements, and achieves multi-agent cross domain collaborative protection to reduce collaborative detection problems caused by data silos.

To achieve the above objectives, the present disclosure provides a vulnerability detection method of power industry control protocols based on federated multi-agent reinforcement learning, including the following steps:
s1: collecting communication traffic of an entire lifecycle of power industrial control protocols, structuring raw data packets to form a structured state database;
s2: obtaining corresponding protocol field data based on the structured state database in s1, and configuring a multi-agent array according to a protocol functional domain division architecture, where consisting a dual network backbone of policy network and value network, which is constructed based on Markov decision process modeling;
where a scale of the multi-agent array adopting a division architecture based on protocol logic functional units, where a single intelligent agent is configured to independently be responsible for anomaly perception and decision-making of a protocol logic functional unit, where the protocol functional domains include but are not limited to identity authentication domain, control instruction domain, parameter configuration domain, and data uplink and downlink domain;
s3: receiving the dual network of s2, combining local private data of each power subject, building a distributed training system based on a personalized federated learning framework, where each power subject trains exclusive deep reinforcement learning models using the local private data, while a central server aggregates model parameters to generate a federated global model and issues updates;
where the federated learning framework is a federated reinforcement learning framework that integrates generative adversarial networks; where the local private data includes historical vulnerability records of each power entity, real-time operation message logs, and corresponding network attack tags;
s4: generating global states, calculating an optimal value function and sample value, preferably selecting high-value samples for training to iteratively update network parameters, and generating preliminary vulnerability detection reports based on the multi-agent array of s2 and the federated global model of s3, combining with a local observation data of multiple agents, introducing an attention mechanism to integrate local observations of multiple agents;
s5: receiving the preliminary vulnerability detection report from s4 and the federated global model from s3, combining with real-time data from a power grid, where each entity deploying local detection nodes based on the federated global model performing decentralized detection, implementing joint fuzzy testing in a digital twin environment, recording vulnerability triggering results, and feeding back to the structured state database and a central server in s1 to assist in optimizing the federated global model in s3.

In some embodiments, in s1, a power industrial control protocol is any one of Modbus/TCP, IEC104, IEC61850 or other power industrial control protocols; where a full lifecycle is a complete business operation process in a power industrial control system, which collects communication traffic from instruction initiation, transmission, device execution to status feedback across an entire chain and multiple nodes; where the communication traffic covers all interactive messages in stages of connection establishment, data transmission, and connection termination.

In some embodiments, in s2, the Markov decision process modeling includes the following element definitions:
a state space S is a behavior sequence and contextual features of the protocol logic functional unit responsible by the intelligent agent within a continuous time window, where the state space S is used to characterize a runtime state of the functional unit;
an action space A is defined as a set of detection actions that an intelligent agent can perform based on a local state of the intelligent agent, where the detection actions include marking normal, reporting suspicious, initiating collaborative diagnosis, and generating functional level test cases;
a state transition probability P is jointly determined by specifications, a current state, and actions executed by the protocol logic functional unit, where the state transition probability P is used to simulate a state evolution law of the protocol logic functional unit in the power industrial control system.

In some embodiments, in s2, the value network is a dual structure consisting of an online network and a target network, where combining with a multi-level reward mechanism and a time difference algorithm to construct a value evaluation system; where the multi-level reward mechanism includes both short-term and long-term rewards;
where the short-term reward Rₛₕₒᵣₜ provides quick feedback for real-time, single-step detection results, where the short-term reward Rₛₕₒᵣₜ is expressed as:

$${R}_{short} = Severity + Novelty - False\_Penalty ;$$

where Severity is a severity score, giving rewards based on a predefined severity level of the vulnerability when an action triggers a vulnerability; Novelty is a novelty score, which encourages intelligent agents to discover new and rare protocol states; False_Penalty is a punishment for false reporting, which imposes a penalty if the intelligent agent misjudges normal traffic as an attack;

where the long-term reward R_{Long} aims to evaluate the final outcome of an attack chain composed of a series of actions, which is usually calculated at the end of an episode and traced back to each step through credit allocation techniques, where the long-term reward R_{Long} is expressed as:

$${R}_{Long} = β * \sum ( {γ}^{T - t} * {A}_{j} ) ;$$

where, β is a success coefficient, which only gives a huge positive reward when a known advanced persistent threat attack chain is fully reproduced or an unprecedented complex zero day vulnerability is discovered; γ is a discount factor; γ^{T-t} represents that the closer the step is to a successful attack time step T is, the less the reward decay of a contribution; Aⱼ is a contribution weight of the j-th step in the attack chain.

In some embodiments, in s2, learning is achieved by optimizing an objective function Rₜ that combines traditional cumulative discount returns with adaptive exploration terms based on temporal differential errors, where the objective function Rₜ is expressed as:

$${R}_{( τ )} = E [ \sum {γ}^{t} * r ( {s}_{t} , {a}_{t} ) + λ * \sum TDerror ] ;$$

where, E[·] is an expectation function, γ is a discount factor; Σγ^{t}*r(sₜ,αₜ) is a standard cumulative discount return; λ is an exploration coefficient; ΣTDerror is a total sum of temporal differential errors in a trajectory;
where, the temporal differential error TDerror is expressed as:

$$TDerror = / R + γ * max Q ( {s}_{t + 1} , a ) - Q ( {s}_{t} , {a}_{t} ) /$$

where, R is a cumulative reward, γ is a discount factor, Q(sₜ, αₜ) is an estimated value of executing action αₜ in a state sₜ, and max Q(sₜ₊₁, αₜ) is a maximum estimated value that may be obtained in a next state sₜ₊₁.

In some embodiments, adopting a personalized federated learning strategy, where each power entity fine tunes the global model using local data to generate a personalized detection model adapted to a local data distribution for subsequent steps after obtaining the global model; where the personalized federated learning strategy can be implemented through any of the following methods: initializing model based on meta learning, adding regularization constraints with the global model to local training objectives on a client side, or jointly training global shared parameters and client specific parameters through a multi-task learning framework.

In some embodiments, in s4, calculating interaction weights between intelligent agents through the attention mechanism, which specifically includes:
for an agent i, dot product calculating a generated query vector Qᵢ with key vectors Kⱼ of all agents (including itself), where an attention weight αᵢⱼ is normalized through a Softmax function:

$${a}_{ij} = Softmax ( {Q}_{i} , {K}_{j} ) ;$$

The present disclosure also provides a vulnerability detection system of power industry control protocols based on federated multi-agent reinforcement learning, including:
a data collection and parsing module, which is used for collecting a full chain communication traffic of power industrial control protocols, and structurally parsing and serializing original data packets through a configurable parsing engine, constructing a temporal state database;
a multi-agent collaborative modeling module, connecting with the data collection and parsing module, where it is used for initializing multi-agent arrays based on protocol functional domain partitioning mechanism and constructing dual network models based on Markov decision processes for each agent;
a personalized federal reinforcement learning training module, connecting with the multi-agent collaborative modeling module for processing the initialization data, which is used for coordinating various power entities to train personalized deep reinforcement learning models in parallel based on local data under a federated learning architecture, and for aggregating and distributing model parameters through a central server;
an intelligent decision-making and vulnerability detection module, connecting with the personalized federal reinforcement learning training module, which is used for achieving collaborative fusion of multi-agent local observations through the attention mechanism, generating a global state view, optimizing network parameters based on priority sampling mechanisms, and outputting preliminary vulnerability detection reports;
a decentralized verification and closed-loop optimization module, which is used for deploying local detection nodes in digital twin environments, combining with generative adversarial networks and syntax-guided fuzzy testing techniques for joint security verification, and feedback detection results to the system front-end and training module to form a closed-loop optimization mechanism.

Therefore, the present disclosure adopts the vulnerability detection method of power industry control protocols based on federated multi-agent reinforcement learning. Compared with the existing technology, the technical solution of the present disclosure has the following beneficial effects:
(1) Adopting the multi-agent array to dynamically generate test cases and a hybrid use case generation mechanism combining Genetic Algorithm and GAN, the detection system can dynamically adjust detection strategies based on a real-time status of a power grid, significantly improving discovery and response speed of unknown vulnerabilities and meeting an urgent need for high real-time security protection in the power system;
(2) Adopting a multi-agent division of labor architecture based on protocol functional domains, combined with the attention mechanism to achieve collaborative decision-making, enabling the system to comprehensively perceive a correlation characteristics of protocol multi fields and multi states, effectively identify complex vulnerabilities and potential attack chains that require cross field collaborative analysis, and eliminate blind spots in a detection field of traditional single agent architecture;
(3) Integrating personalized federated reinforcement learning, supporting local training of models based on private data from various power enterprises. Where all power entities only need to share model parameters instead of raw data, which not only avoids the risk of sensitive protocol data leakage and meets strict compliance requirements, but also breaks data silos and builds a decentralized cross-domain collaborative security protection system.

The technical solution of the present disclosure will be further described in detail through accompanying drawings and embodiments.

### BRIEF DESCRIPTION OF THE DRAWINGS

FIG. 1 shows a flowchart of an embodiment of the vulnerability detection method of power industry control protocols based on federated multi-agent reinforcement learning according to the present disclosure.

### DETAILED DESCRIPTION OF THE EMBODIMENTS

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. All other embodiments obtained by ordinary technical personnel in the field without creative labor are within the scope of protection of the present disclosure. Unless otherwise defined, technical or scientific terms used in the present disclosure shall have usual meanings as understood by those skilled in the art to which the present disclosure belongs.

### Embodiment 1

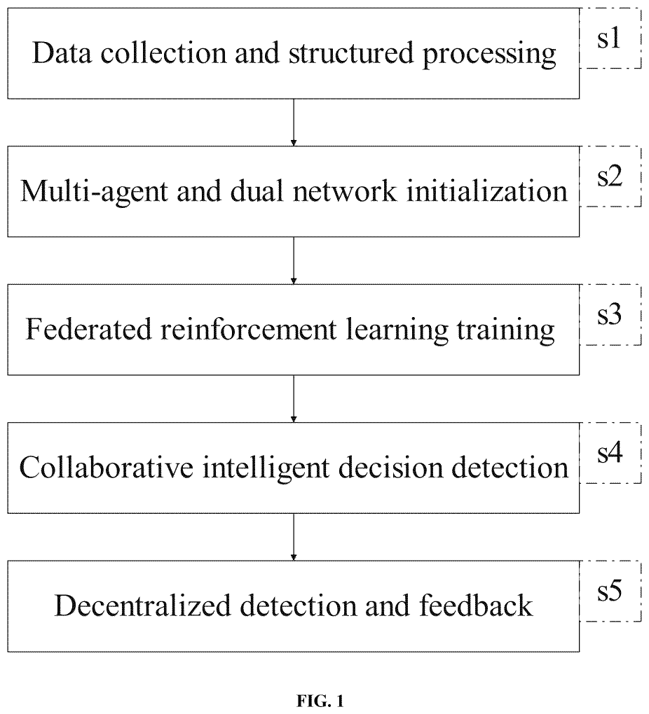

As shown in FIG. 1, the vulnerability detection method of power industry control protocols based on federated multi-agent reinforcement learning of the present disclosure includes the following steps:
s1: Using deep packet analysis (DPI) technology, capturing a communication traffic of an entire lifecycle of 12 types of power industrial control protocols, such as Modbus/TCP and IEC104, covering complete session states such as connection establishment, data transmission, and connection termination.

Structuring collected information and using DPI technology to extract protocol fields; classifying and labeling raw data packets according to session characteristics based on protocol state machine modeling; building a structured state database that supports precise retrieval of spatiotemporal dimensions to obtain a protocol full state data pool;
the data pool supports precise retrieval in the spatiotemporal dimension. For example, a retrieval condition is “Substation A-14:00-15:00-IEC61850 Protocol-Message Verification Failure”, which provides high-quality sample data for subsequent intelligent agent training, that includes session states of various protocols throughout their lifecycle, structured data packets after classification and labeling;
s2: adopting a division architecture based on protocol logic functional domains, allocating dedicated agents to each core functional domain. For example, session management agents focus on analyzing connection establishment, maintenance, and termination sequences, detecting session hijacking and flooding attacks. Where an instruction control intelligent agent is responsible for monitoring key control commands such as closing and opening switches, identifying malicious instructions and illegal operation sequences; a data read-write intelligent agent is responsible for processing parameter configuration, data recording, and other read-write operations, detecting data tampering and abnormal transmission;
retrieving data from the structured state database in s1; using model distillation compression technology and knowledge distillation method, compressing a teacher model with billions of parameters into a student model with millions of parameters. Where a distillation loss function is expressed as:

$${ℒ}_{KD} = η {ℒ}_{CE} ( {y}_{s} , y ) + ( 1 - η ) \cdot {ℒ}_{MSE} ( {Z}_{s} / ϕ , {Z}_{t} / ϕ ) ;$$

where, [symbol] _{KD} is a distillation loss function; η is a balance coefficient of the distillation loss function; [symbol] _{CE} is a cross entropy loss function; [symbol] _{MSE} is a mean square error loss function; zₛ is a feature representation in a middle layer of a student model; zₜ is a feature representation in a middle layer of a teacher model; φ is a temperature parameter;
after a compression, a number of parameters is significantly reduced and an inference time is reduced to ensure an efficient operation of multi-agent systems in resource-constrained power edge nodes;
and initializing the policy network and value network;
the Markov decision process modeling includes the following element definitions:
a state space S is a behavior sequence and contextual features of the protocol logic functional unit responsible by the intelligent agent within a continuous time window, where the state space S is used to characterize a runtime state of the functional unit;
an action space A is defined as a set of detection actions that an intelligent agent can perform based on a local state of the intelligent agent, where the detection actions include marking normal, reporting suspicious, initiating collaborative diagnosis, and generating functional level test cases;
a state transition probability P is jointly determined by specifications, a current state, and actions executed by the protocol logic functional unit, where the state transition probability P is used to simulate a state evolution law of the protocol logic functional unit in the power industrial control system.

The policy network adopts a recurrent neural network structure that includes gated recurrent units (GRUs), with an input being a temporal behavior characteristic of a functional unit, where the recurrent neural network structure is responsible for (such as an input of a session management agent is connection frequency and survival duration sequence). The policy network automatically focuses on key time step features through a built-in attention module, and finally outputs a probability distribution of each detected action (such as marking normal, reporting suspicious) in an action space through the Softmax function, thereby guiding an agent to implement vulnerability detection decisions.

The value network adopts a dual structure consisting of an online network and a target network, where an input is a quasi-global state view generated by an attention mechanism, where the quasi-global state view integrates collaborative information of all agents. The value network constructs an accurate value evaluation system for state-action pairs based on a multi-level reward signal that combines short-term immediate rewards and long-term sequential rewards through a time difference algorithm;
the short-term reward Rₛₕₒᵣₜ measures the success rate of vulnerability triggering, where the short-term reward Rₛₕₒᵣₜ is expressed as:

$${R}_{short} = Severity + Novelty - False\_Penalty ;$$

where Severity is a severity score, giving rewards based on a predefined severity level of the vulnerability when an action triggers a vulnerability; Novelty is a novelty score, which encourages intelligent agents to discover new and rare protocol states; False_Penalty is a punishment for false reporting, where if the intelligent agent misjudges normal traffic as an attack, imposing a penalty;
the long-term reward R_{Long} measures the integrity of an attack chain; where the long-term reward R_{Long} is expressed as:

$${R}_{Long} = β * \sum ( {γ}^{T - t} * {A}_{j} ) ;$$

where, β is a success coefficient, which only gives a huge positive reward when a known advanced persistent threat attack chain is fully reproduced or an unprecedented complex zero day vulnerability is discovered; γ is a discount factor; γ^{T-t} represents that the closer the step is to a successful attack time step T is, the less the reward decay of a contribution; Aⱼ is a contribution weight of the j-th step in the attack chain;
learning through an objective function Rₜ that combined traditional cumulative discount returns with adaptive exploration terms based on temporal differential errors, where the objective function Rₜ is expressed as:

$${R}_{( τ )} = E [ \sum {γ}^{t} * r ( {s}_{t} , {a}_{t} ) + λ * \sum TDerror ] ;$$

where, E[·] is an expectation function, γ is a discount factor; Σγ^{t}*r(sₜ,αₜ) is a standard cumulative discount return; λ is an exploration coefficient; ΣTDerror is a total sum of temporal differential errors in a trajectory;
where, the temporal differential error TDerror is expressed as:

$$TDerror = / R + γ * max Q ( {s}_{t + 1} , a ) - Q ( {s}_{t} , {a}_{t} ) / ;$$

where, R is a cumulative reward, γ is a discount factor, Q(sₜ, αₜ) is an estimated value of executing action αₜ in a state sₜ, and max Q(sₜ₊₁, αₜ) is a maximum estimated value that may be obtained in a next state sₜ₊₁;
therefore, intelligent agents are motivated to explore high-value state areas and are guided to actively explore and accurately evaluate the value of states;
s3: receiving the dual network of s2, building a distributed training system based on a federated reinforcement learning framework that integrates generative adversarial networks;
where multiple entities (such as power generation companies, power grid companies, etc) train a dedicated deep reinforcement learning (DRL) model using local private data (includes historical vulnerability features, real-time message sequences, and corresponding security labels). All raw sensitive data are retained locally, and only locally trained model parameters are uploaded to the central server;
central server using a personalized federated learning strategy, considering the data size of each node, a local model performance is introduced as a weighted basis to generate a more generalized global reference model. Subsequently, the global reference model is distributed to all participating parties. On this basis, each power entity can fine tune their own unique data distribution to ultimately obtain personalized detection models that possess both global knowledge and local characteristics, in order to effectively address common problems of data heterogeneity in the power Internet of Things;
s4: receiving the multi-agent array of s2 and the federated global model of s3, intelligent agents achieve collaborative perception and decision-making by introducing an attention mechanism as a collaborative center, where the intelligent decision-making process includes global state evaluation, sample value calculation, and subsequently executes high-value sample priority training;
global state evaluation is based on local observations of functional domains, generating respective query, key, and value vectors, weight fusing local information from all agents, a context-rich quasi-global state view is formed by dynamically calculating attention weights;
sample value calculation providing long-term benefit estimation for decision-making by calculating the optimal value function through the value network, the policy network optimizes a detection action strategy based on value guidance and environmental feedback. At the same time, the system calculates a temporal difference error of each empirical sample to measure value and importance.

High-value sample priority training adopts a priority experience replay mechanism, assigning different sampling priorities to different samples based on temporal differential errors. Prior to replaying high-value samples that can effectively trigger protocol state anomalies for training, accelerating model convergence, and finally, generating preliminary vulnerability detection reports based on the collaborative decision-making results.
s5: receiving the preliminary vulnerability detection reports from s4, optimized dual network parameters, and the federated global model of s3. Combining with real-time data from a power grid, each entity deploys detection nodes locally, microservicing the protocol simulation environment, reducing resource consumption and independently executing vulnerability detection tasks that rely on a containerized execution environment and a lightweight runtime built on Docker and the Ollama framework.

In a detection execution, the system combines generative adversarial networks and a reinforcement learning framework. Where a generator of the generative adversarial network learns normal message distribution, synthesizes covert abnormal packets, such as messages with valid formats but abnormal field values, and adjusts use case strategy in real time based on power grid load fluctuations and topology change data; each node conducts fuzzy testing on local power protocols and records results of vulnerability triggering, such as whether causes protocol interruption or data tampering;
adding test results as new samples to the structured state database of s1 for local model iteration; by utilizing the local Application Programming Interface (API) of an artificial intelligence (AI) model provided by Ollama, statistical data (non raw data) such as vulnerability triggering frequency and new vulnerability types can be uploaded to the central server to assist in global model optimization in s3 and improve zero day vulnerability response speed.

As a result, the present disclosure adopts the vulnerability detection method of power industry control protocols based on federated multi-agent reinforcement learning. The method achieves rapid, accurate, and collaborative detection of power protocol vulnerabilities, especially zero-day vulnerabilities, through an organic combination of multi-agent collaboration based on functional domain division, personalized federated learning for data privacy protection, and security verification driven by digital twins. The method not only significantly improves detection efficiency and real-time protection capabilities, but also fundamentally solves compliance challenges of sensitive data sharing and technical barriers of cross-domain collaboration, providing an active security defense solution for the power Internet of Things that combines intelligence, security, and scalability.

Technicians in the field should understand that the embodiments of the present disclosure can be provided as methods, systems, or computer program products. Therefore, the present disclosure may take the form of a fully hardware embodiment, a fully software embodiment, or an embodiment combined of software and hardware. Moreover, the present disclosure may take the form of a computer program product implemented on one or more computer usable storage media (including but not limited to disk storage, CD-ROM, optical storage, etc.) containing computer usable program code.

Finally, it should be noted that the embodiments are only used to illustrate the technical solution of the present disclosure and not to limit it. Although the present disclosure has been described in detail with reference to the preferred embodiments, those skilled in the art should understand that they can still modify or replace the technical solution of the present disclosure, and modifications or equivalent substitutions cannot make a modified technical solution deviate from the spirit and scope of the technical solution of the present disclosure.

What is claimed is:

1. A vulnerability detection method of power industry control protocols based on federated multi-agent reinforcement learning, comprising the following steps:
s1: collecting communication traffic of an entire lifecycle of power industrial control protocols, and structuring raw data packets to form a structured state database;
s2: obtaining corresponding protocol field data based on the structured state database in s1, and configuring a multi-agent array according to a protocol functional domain division architecture, consisting of a dual network backbone of policy network and value network constructed based on Markov decision process modeling;
wherein a scale of the multi-agent array adopts a division architecture based on protocol logic functional units, wherein a single intelligent agent is configured to independently be responsible for anomaly perception and decision-making of a protocol logic functional unit, wherein the protocol functional domains comprise but are not limited to: identity authentication domain, control instruction domain, parameter configuration domain, and data uplink and downlink domain;
s3: receiving the dual network of s2, combining local private data of each power subject, and building a distributed training system based on a personalized federated learning framework, wherein each power subject trains exclusive deep reinforcement learning models using the local private data, while a central server aggregates model parameters to generate a federated global model and issues updates;
wherein, the personalized federated learning framework is a federated reinforcement learning framework that integrates generative adversarial networks; wherein the local private data comprises historical vulnerability records of each power entity, real-time operation message logs, and corresponding network attack tags;
s4: generating global states, calculating an optimal value function and sample value, preferably selecting high-value samples for training to iteratively update network parameters, and generating preliminary vulnerability detection reports based on the multi-agent array of s2 and the federated global model of s3, combining with a local observation data of a plurality of agents, and introducing the attention mechanism to integrate local observations of a plurality of agents;
s5: receiving the preliminary vulnerability detection report from s4 and the federated global model from s3, and combining with real-time data from a power grid, with each entity deploying local detection nodes based on the federated global model performing decentralized detection, implementing joint fuzzy testing in a digital twin environment, recording vulnerability triggering results, and feeding back to the structured state database and a central server in s1 to assist in optimizing the federated global model in s3.

2. The vulnerability detection method of power industry control protocols based on federated multi-agent reinforcement learning according to claim 1, wherein in s1, a power industrial control protocol is any one of Modbus/TCP, IEC104, IEC61850 or other power industrial control protocol; wherein a full lifecycle is a complete business operation process in a power industrial control system, which collects communication traffic from instruction initiation, transmission, device execution to status feedback across an entire chain and a plurality of nodes; wherein the communication traffic covers all interactive messages in stages of connection establishment, data transmission, and connection termination.

3. The vulnerability detection method of power industry control protocols based on federated multi-agent reinforcement learning according to claim 1, wherein in s2, the Markov decision process modeling comprises the following element definitions:
a state space S is a behavior sequence and contextual features of the protocol logic functional unit responsible by the intelligent agent within a continuous time window, wherein the state space S is used to characterize a runtime state of the functional unit;
an action space A is defined as a set of detection actions that an intelligent agent can perform based on a local state of the intelligent agent, wherein the detection actions comprise marking normal, reporting suspicious, initiating collaborative diagnosis, and generating functional level test cases;
a state transition probability P is jointly determined by specifications, a current state, and actions executed by the protocol logic functional unit, wherein the state transition probability P is used to simulate a state evolution law of the protocol logic functional unit in the power industrial control system.

4. The vulnerability detection method of power industry control protocols based on federated multi-agent reinforcement learning according to claim 1, wherein in s2, the value network is a dual structure consisting of an online network and a target network, combining with a multi-level reward mechanism and a time difference algorithm to construct a value evaluation system; wherein the multi-level reward mechanism comprises short-term rewards and long-term rewards;
wherein the short-term reward Rₛₕₒᵣₜ provides quick feedback for real-time, single-step detection results, wherein the short-term reward Rₛₕₒᵣₜ is expressed as:
$${R}_{s hort} = Severity + Novelty - False\_Penalty ;$$
wherein, Severity is a severity score, assigning rewards based on a predefined severity level of the vulnerability when an action triggers a vulnerability; Novelty is a novelty score, which encourages intelligent agents to discover new and rare protocol states; False_Penalty is a punishment for false reporting, which imposes a penalty if the intelligent agent misjudges normal traffic as an attack, imposing a penalty;
wherein the long-term reward R_{Long} aims to evaluate the final outcome of an attack chain composed of a series of actions, which is usually calculated at the end of an episode and traced back to each step through credit allocation techniques, wherein the long-term reward R_{Long} is expressed as:
$${R}_{L o n g} = β * \sum ( {γ}^{T - t} * {A}_{j} ) ;$$
wherein, β is a success coefficient, which only gives a huge positive reward when a known advanced persistent threat attack chain is fully reproduced or an unprecedented complex zero day vulnerability is discovered; γ is a discount factor; γ^{T-t} represents that the closer the step is to a successful attack time step T is, the less the reward decay of a contribution; Aⱼ is a contribution weight of the j-th step in the attack chain.

5. The vulnerability detection method of power industry control protocols based on federated multi-agent reinforcement learning according to claim 1, wherein in s2, learning is achieved by optimizing an objective function Rₜ that combines traditional cumulative discount returns with adaptive exploration terms based on temporal differential errors, wherein the objective function Rₜ is expressed as:
$${R}_{( τ )} = E [ \sum {γ}^{t} * r ( {s}_{t} , {a}_{t} ) + λ * \sum TDerror ] ;$$
wherein, E[·] is an expectation function, γ is a discount factor; Σγ^{t}*r(sₜ,αₜ) is a standard cumulative discount return; λ is an exploration coefficient; ΣTDerror is a total sum of temporal differential errors in a trajectory;
wherein, the temporal differential error TDerror is expressed as:
$$TDerror = / R + γ * max Q ( {s}_{t + 1} , a ) - Q ( {s}_{t} , {a}_{t} ) / ;$$
wherein, R is a cumulative reward, γ is a discount factor, Q(sₜ,αₜ) is an estimated value of executing action αₜ in a state sₜ, and max Q(sₜ₊₁, αₜ) is a maximum estimated value that may be obtained in a next state sₜ₊₁.

6. The vulnerability detection method of power industry control protocols based on federated multi-agent reinforcement learning according to claim 1, wherein in s3, adopting a personalized federated learning strategy, each power entity fine tunes the global model using local data to generate a personalized detection model adapted to a local data distribution for subsequent steps after obtaining the global model; wherein the personalized federated learning strategy can be implemented through any of the following methods: initializing a model based on meta learning, adding regularization constraints with the global model to local training objectives on a client side, or jointly training global shared parameters and client specific parameters through a multi-task learning framework.

7. The vulnerability detection method of power industry control protocols based on federated multi-agent reinforcement learning according to claim 1, wherein in s4, calculating interaction weights between intelligent agents through the attention mechanism, specifically comprises:
for an agent i, dot product calculating a generated query vector Qᵢ with key vectors Kⱼ of all agents (comprising itself), wherein an attention weight αᵢⱼ is normalized through a Softmax function:
$${a}_{ij} = Softma x ( {Q}_{i} , {K}_{j} ) ;$$

8. A vulnerability detection system of power industry control protocols based on federated multi-agent reinforcement learning, which is applied in the vulnerability detection method of power industry control protocols according to claim 1, wherein the detection system of power protocol vulnerability comprises:
a data collection and parsing module, configured for collecting communication traffic of an entire lifecycle of power industrial control protocols, structuring raw data packets to form a structured state database;
a multi-agent collaborative modeling module, configured for connecting with the data collection and parsing module, configured, based on the time-series structured state sequence, to initialize the multi-agent array according to a protocol functional domain division architecture, and construct a dual network model consisting of a policy network and a value network for each agent based on the Markov decision process;
a federal reinforcement learning training module, configured for connecting with the personalized federated training module for processing initialization data, comprising receiving the dual network, combining local private data of each power subject, and building a distributed training system based on a personalized federated learning framework, wherein each power subject trains exclusive deep reinforcement learning models using the local private data, generating a federated global model and issues updates through a central server using personalized federated learning algorithms;
a collaborative intelligent decision detection module, configured for connecting with the federal reinforcement learning training module, comprising receiving multi-agent arrays and personalized detection models, introducing an attention mechanism as collaborative hubs to integrate local observations of each agent and generate a quasi global state view, calculating an optimal value function and updating network parameters using a priority experience replay strategy, and generating a preliminary vulnerability detection report based on the quasi global state view;
a decentralized detecting feedback module, configured for connecting with the collaborative intelligent decision detection module, scheduling agents to perform localization detection based on the preliminary vulnerability detection report and the global model, driving a generation of countermeasures network to generate exception test cases that conform to protocol syntax for joint fuzzy testing in a digital twin environment; synchronizing vulnerability results triggered during detecting, providing feedback to a time-series database of the data collection and parsing module and a central server of the personalized federal reinforcement learning training module, and forming a closed-loop optimization system.

9. The vulnerability detection system of power industry control protocols based on federated multi-agent reinforcement learning according to claim 8, wherein in s1, a power industrial control protocol is Modbus/TCP, IEC104, IEC61850 power industrial control protocol; wherein a full lifecycle is a complete business operation process in a power industrial control system, which collects communication traffic from instruction initiation, transmission, device execution for status feedback across an entire chain and a plurality of nodes; wherein the communication traffic covers all interactive messages in stages of connection establishment, data transmission, and connection termination

10. The vulnerability detection system of power industry control protocols based on federated multi-agent reinforcement learning according to claim 8, wherein in s2, the Markov decision process modeling comprises the following element definitions:
a state space S is a behavior sequence and contextual features of the protocol logic functional unit responsible by the intelligent agent within a continuous time window, wherein the state space S is used to characterize a runtime state of the functional unit;
an action space A is defined as a set of detection actions that an intelligent agent can perform based on a local state of the intelligent agent, wherein the detection actions comprise marking normal, reporting suspicious, initiating collaborative diagnosis, and generating functional level test cases;
a state transition probability P is jointly determined by specifications, a current state, and actions executed by the protocol logic functional unit, wherein the state transition probability P is used to simulate a state evolution law of the protocol logic functional unit in the power industrial control system.

11. The vulnerability detection system of power industry control protocols based on federated multi-agent reinforcement learning according to claim 8, wherein in s2, the value network is a dual structure consisting of an online network and a target network, configured for combining with a multi-level reward mechanism and a time difference algorithm to construct a value evaluation system; wherein the multi-level reward mechanism comprises short-term rewards and long-term rewards;
wherein the short-term reward Rₛₕₒᵣₜ provides quick feedback for real-time, single-step detection results, wherein the short-term reward Rₛₕₒᵣₜ is expressed as:
$${R}_{s hort} = Severity + Novelty - False\_Penalty ;$$
wherein, Severity is a severity score, giving rewards based on a predefined severity level of the vulnerability when an action triggers a vulnerability; Novelty is a novelty score, which encourages intelligent agents to discover new and rare protocol states; False_Penalty is a punishment for false reporting, wherein if the intelligent agent misjudges normal traffic as an attack, imposing a penalty;
wherein the long-term reward R_{Long} aims to evaluate the final outcome of an attack chain composed of a series of actions, which is usually calculated at the end of an episode and traced back to each step through credit allocation techniques, wherein the long-term reward R_{Long} is expressed as:
$${R}_{L o n g} = β * \sum ( {γ}^{T - t} * {A}_{j} ) ;$$
wherein, β is a success coefficient, which only gives a huge positive reward when a known advanced persistent threat attack chain is fully reproduced or an unprecedented complex zero day vulnerability is discovered; γ is a discount factor; γ^{T-t} represents that the closer the step is to a successful attack time step T is, the less the reward decay of a contribution; Aⱼ is a contribution weight of the j-th step in the attack chain.

12. The vulnerability detection system of power industry control protocols based on federated multi-agent reinforcement learning according to claim 8, wherein in s2, learning is achieved by optimizing an objective function Rₜ that combines traditional cumulative discount returns with adaptive exploration terms based on temporal differential errors, wherein the objective function Rₜ is expressed as:
$${R}_{( τ )} = E [ \sum {γ}^{t} * r ( {s}_{t} , {a}_{t} ) + λ * \sum TDerror ] ;$$
wherein, E[·] is an expectation function, γ is a discount factor; Σγ^{t}*r(sₜ, αₜ) is a standard cumulative discount return; λ is an exploration coefficient; ΣTDerror is a total sum of temporal differential errors in a trajectory;
wherein, the temporal differential error TDerror is expressed as:
$$TDerror = / R + γ * max Q ( {s}_{t + 1} , a ) - Q ( {s}_{t} , {a}_{t} ) / ;$$
wherein, R is a cumulative reward, γ is a discount factor, Q(sₜ, αₜ) is an estimated value of executing action αₜ in a state sₜ, and max Q(sₜ₊₁, αₜ) is a maximum estimated value that may be obtained in a next state sₜ₊₁

13. The vulnerability detection system of power industry control protocols based on federated multi-agent reinforcement learning according to claim 8, wherein in s3, a personalized federated learning strategy is adopted, wherein each power entity fine tunes the global model using local data to generate a personalized detection model adapted to a local data distribution for subsequent steps after obtaining the global model; wherein the personalized federated learning strategy can be implemented through any of the following methods: initializing model based on meta learning, adding regularization constraints with the global model to local training objectives on a client side, or jointly training global shared parameters and client specific parameters through a multi-task learning framework.

14. The vulnerability detection system of power industry control protocols based on federated multi-agent reinforcement learning according to claim 8, wherein s4 comprises calculating interaction weights between intelligent agents through the attention mechanism, which specifically comprises:
for an agent i, dot product calculating a generated query vector Qᵢ with key vectors Kⱼ of all agents (comprising itself), wherein an attention weight αᵢⱼ is normalized through a Softmax function:
$${a}_{ij} = Softma x ( {Q}_{j} , {K}_{j} ) .$$

15. A computer system, which is applied in the vulnerability detection method of power industry control protocols based on federated multi-agent reinforcement learning according to claim 1, wherein the computer equipment of power protocol vulnerability comprises: a processor for coupling with a memory, reading and executing instructions and/or program code in a memory.

16. The computer system of claim 15, wherein in s1, a power industrial control protocol is Modbus/TCP, IEC104, IEC61850 power industrial control protocol; wherein a full lifecycle is a complete business operation process in a power industrial control system, which collects communication traffic from instruction initiation, transmission, device execution to status feedback across an entire chain and a plurality of nodes; wherein the communication traffic covers all interactive messages in stages of connection establishment, data transmission, and connection termination.

17. The computer system of claim 15, wherein in s2, the Markov decision process modeling comprises the following element definitions:
a state space S is a behavior sequence and contextual features of the protocol logic functional unit responsible by the intelligent agent within a continuous time window, wherein the state space S is used to characterize a runtime state of the functional unit;
an action space A is defined as a set of detection actions that an intelligent agent can perform based on a local state of the intelligent agent, wherein the detection actions comprise marking normal, reporting suspicious, initiating collaborative diagnosis, and generating functional level test cases;
a state transition probability P is jointly determined by specifications, a current state, and actions executed by the protocol logic functional unit, wherein the state transition probability P is used to simulate a state evolution law of the protocol logic functional unit in the power industrial control system.

18. The computer system of claim 15, wherein in s2, the value network is a dual structure consisting of an online network and a target network, combining with a multi-level reward mechanism and a time difference algorithm to construct a value evaluation system; wherein the multi-level reward mechanism comprises short-term rewards and long-term rewards;
wherein the short-term reward Rₛₕₒᵣₜ provides quick feedback for real-time, single-step detection results, wherein the short-term reward Rₛₕₒᵣₜ is expressed as:
$${R}_{s hort} = Severity + Novelty - False\_Penalty ;$$
wherein, Severity is a severity score, assigning rewards based on a predefined severity level of the vulnerability when an action triggers a vulnerability; Novelty is a novelty score, which encourages intelligent agents to discover new and rare protocol states; False_Penalty is a punishment for false reporting, wherein if the intelligent agent misjudges normal traffic as an attack, imposing a penalty;
wherein the long-term reward R_{Long} aims to evaluate the final outcome of an attack chain composed of a series of actions, which is usually calculated at the end of an episode and traced back to each step through credit allocation techniques, wherein the long-term reward R_{Long} is expressed as:
$${R}_{L o n g} = β * \sum ( {γ}^{T - t} * {A}_{j} ) ;$$
wherein, β is a success coefficient, which only gives a huge positive reward when a known advanced persistent threat attack chain is fully reproduced or an unprecedented complex zero day vulnerability is discovered; γ is a discount factor; γ^{T-t} represents that the closer the step is to a successful attack time step T is, the less the reward decay of a contribution; Aⱼ is a contribution weight of the j-th step in the attack chain.

19. The computer system of claim 15, wherein in s2, learning is achieved by optimizing an objective function Rₜ that combines traditional cumulative discount returns with adaptive exploration terms based on temporal differential errors, wherein the objective function Rₜ is expressed as:
$${R}_{( τ )} = E [ \sum {γ}^{t} * r ( {s}_{t} , {a}_{t} ) + λ * \sum TDerror ] ;$$
wherein, E[·] is an expectation function, γ is a discount factor; Σγ^{t}*r(sₜ,αₜ) is a standard cumulative discount return; λ is an exploration coefficient; ΣTDerror is a total sum of temporal differential errors in a trajectory;
wherein, the temporal differential error TDerror is expressed as:
$$TDerror = / R + γ * max Q ( {s}_{t + 1} , a ) - Q ( {s}_{t} , {a}_{t} ) / ;$$
wherein, R is a cumulative reward, γ is a discount factor, Q(sₜ, αₜ) is an estimated value of executing action αₜ in a state sₜ, and max Q(sₜ₊₁,αₜ) is a maximum estimated value that may be obtained in a next state sₜ₊₁.

20. The computer system of claim 15, wherein in s3, adopting a personalized federated learning strategy, each power entity fine tunes the global model using local data to generate a personalized detection model adapted to a local data distribution for subsequent steps after obtaining the global model; wherein the personalized federated learning strategy can be implemented through any of the following methods: initializing a model based on meta learning, adding regularization constraints with the global model to local training objectives on a client side, or jointly training global shared parameters and client specific parameters through a multi-task learning framework.
